(19) United States
(12) Patent Application Publication
(10) Pub. No.: US 2021/0053753 A1
(43) Pub. Date: Feb. 25, 2021

(54) LIQUID-SEALED FLUID CONTAINER-BASED CYCLIC INERT SEALING SYSTEM AND QHSE STORAGE AND TRANSPORTATION METHOD

(71) Applicant: Qiangdan SUN, Beijing (CN)

(72) Inventor: Qiangdan SUN, Beijing (CN)

(21) Appl. No.: 16/966,812

(22) PCT Filed: Mar. 25, 2019
(86) PCT No.: PCT/CN2019/079567

§ 371 Date: Nov. 10, 2020

(30) Foreign Application Priority Data
Feb. 2, 2018 (CN) 201810106955.3
Jan. 31, 2019 (CN) 201910097555.5

(51) Int. Cl. B65D 88/78; B67D 7/76

(52) U.S. Cl. CPC B65D 88/78; B67D 7/76

(57) ABSTRACT

A new Abstract is submitted herewith following page 9 of this paper.

### TECHNICAL FIELD

The present invention relates to the technical field of fluid material storage and transportation, in particular to a liquid-sealed fluid container, a cyclic inert sealing system based on the liquid-sealed fluid container, and a quality-health-safety-environmental (QHSE for short) storage and transportation method based on the cyclic inert sealing system.

### BACKGROUND ART

Materials with strategic resource attributes, such as oil and its products, are both a support for national strength and a component for combat power. As such materials and their storage and transportation methods, engineering facilities and technical equipment are in common use of military-civil aspects, it is inevitable that they will become the focus of strategic interests and the key tactical attack and defense in the military struggle. However, under the current background of contemporary attack forces, which are commonly deployed and commonly encountered in actual combat and normal deterrence, the front-stage earth-boring and\or container detonation, and then devastated oil and gas, detonated materials, resulting in the overall chemical explosion attack after the significant damage, cost-effective, is to destroy the military oil supply project, the national strategic reserve, chemical industry park, and ship, ship power oil cabinet , roads, railway tankers and other important military and economic goals of the basic model, the election of the best species and tactics. Therefore, the self-defense capability for dealing with detonation mode attack in containers is indispensable, under the condition that the existing self-defense technology for military fuel supply projects is limited to the cave depot hidden engineering and fire protection technology.

In addition, it is well-known that bulk liquid hazardous chemicals generate volatile organic compounds (VOCs) due to inter-phase mass transfer, which are not only well-known precursors, carcinogens, haze contributors, but also focus on monitoring and controlling objectives by the government which involves public safety, life and health, environmental protection, cleaner production, material quality and energy-saving emission reduction and other areas. However, the conventional art in different areas involving bulk liquid hazardous chemicals and containers often run counter to one another. For example, in the case of a container without an inner floating roof being regarded as an unorganized discharge technology, the existing inner floating roof storage tank is provided with ventilation windows to ensure smooth breathing and eliminate the safety risk of hydrocarbon accumulation. However, air pollution caused by the continuity of the volatile, escape on the sealing device has not been included as a mandatory control areas; the conventional floating roof with nitrogen sealing technology further ensures the system oxygen safety and inhibits material oxidation and deterioration, but while the mass transfer products are expelled from the storage tank and accompanied by the process of nitrogen bleed, the environmental pollution and the safety hazard at the pressure relief valve port have not been solved yet. The conventional self-sealing gas-liquid exchange recovery technology reduces the material handling, but the air serves as a medium to balance the import and export side of the container process, which causes a result that that explosion risk of the container material mixture in the output side suddenly increases, and the recycling technique is not suitable for all types of floating roof tank.

Therefore, technical solutions aimed at the normal isolation of the atmosphere, dynamic circulating inert seal, gas-free emissions, low operating costs and application to the overall storage and transportation network and value orientation of technological advancement in this area, are both a necessary path of integrated QHSE in engineering and an inevitable choice for generating self-defense capabilities.

### SUMMARY OF THE INVENTION

The object of the present invention is to provide a liquid-sealed fluid container, a cyclic inert sealing system based on the liquid-sealed fluid container, and a QHSE storage and transportation method, which can store and transport fluid materials safely and effectively.

To achieve the above objectives, the present invention provides a liquid-sealed fluid container, which includes:

a container body, provided with an enclosed volume inside for containing fluid material;

a working fluid, which is filled in the enclosed volume by purging oxygen and in liquid phase communication with the working fluid source outside the container body, in order to form a liquid lining structure for the fluid material in the enclosed volume, so that the fluid material in the enclosed volume is isolated from the external gaseous atmosphere of the container body; and

a material transfer control unit, which is connected to the fluid material in the enclosed volume for realizing the input and output control of the fluid material in the enclosed volume;

wherein the working fluid is incompatible or substantially incompatible with the fluid material in the enclosed volume, and the density of the working fluid is greater than that of the fluid material in the enclosed volume.

Preferably, further including:

a liquid-lined pipeline connected to the container body, and the port of the liquid-lined pipeline is located on the lower side or bottom of the container body, or through the container body and suspended above the bottom of the container body;

a liquid-lined transfer control unit, connected to the liquid-lined pipeline and the working fluid source, in order to keep the working fluid form the liquid lining structure in the enclosed volume by means of hydrostatic and/or power driving.

Preferably, the liquid-lined transfer control unit comprises:

a circulating spray component, which is used to spray the working fluid toward the fluid material in the container body for purifying the fluid material.

Preferably, further including:

a working fluid source, which is in liquid phase directly or valve-controlled communicated with the working fluid liquid in the enclosed volume, for providing the working fluid to the liquid lining structure or recovering the working fluid from the liquid lining structure.

Preferably, the working fluid source is a liquid-sealed tank storing the working fluid, and the container body is fixedly or floatingly arranged in the liquid-sealed tank.

Preferably, liquid-lined through holes are provided on the bottom of the container body and/or on the side wall close to the bottom, and the liquid-lined through holes are located below the liquid level of the working fluid stored in the liquid-sealed tank.

Preferably, it further comprises a construction facility arranged outside the liquid-sealed tank, and the container body and the liquid-sealed tank are located in an internal closed space of the construction facility.

Preferably, the construction facility has a dome structure, and the dome structure is hermetically connected with the periphery or edge of the cofferdam of the liquid-sealed tank or manufactured integrally.

Preferably, the liquid-sealed tank is in communication with the atmosphere.

Preferably, the internal closed space is in valve-controlled communication with the atmosphere or is filled with a protective gas.

Preferably, it further comprises a quick-fitting plate arranged on the container body; the material transfer control unit includes a first quick-fitting connection assembly, one end of which is connected to the quick-fitting plate and the other end is used to quickly connect to the fluid material of the material storage and transportation equipment outside the container body; the liquid-lined transfer control unit includes a second quick-fitting connection assembly, one end of which is connected to the quick-fitting plate and the other end is used to quickly connect to the liquid lining structure formed in the material storage and transportation equipment.

Preferably, the fluid material is a gas-liquid two-phase fluid material, and the material transfer control unit includes a gas-phase material transfer control subunit and a liquid-phase material transfer control subunit, the gas-phase material transfer control subunit is used to realize the output control of the gas-phase fluid material in the enclosed volume, and the liquid-phase material transfer control subunit is used to realize the output control of the liquid-phase fluid material in the enclosed volume.

Preferably, the liquid-phase material transfer control subunit comprises a floating body and a liquid-phase pipeline, and the density of the floating body is lower than the density of the liquid-phase fluid material, and a connecting pipe is provided on the floating body to communicate with the liquid-phase fluid material and the liquid-phase pipeline.

Preferably, the container body further comprises a safety valve tube connected to the top of the container body for realizing air drawing, gas discharging and overpressure protection of the entire closed volume.

Preferably, the working fluid source is an open water area, and the water of the open water area is provided as the working fluid, and the container body is floatingly arranged in the open water area.

Preferably, the structure and shape of the container body are designed for seaworthiness.

Preferably, wherein the structure and shape of the container body are designed as for submarine.

Preferably, it further comprises a buoyancy control unit for controlling the sinking and floating of the container body in the open water.

Preferably, the working fluid source is an underground water source, and water from the underground water source is provided as the working fluid, and the container body is wholly or partly fixed or floatingly arranged below the water level of the underground water source.

Preferably, it further comprises a transport vehicle for carrying and transporting the container body.

Preferably, the material transfer control unit further comprises one or more material pipelines, and the ports of the material pipelines are provided on the upper side wall or top of the container body, or through the container body and suspending below the top of the container body.

Preferably, the number of the container body is at least two, and the at least two container bodies are arranged in parallel, series or series-parallel.

Preferably, it further comprises at least one of the following components:

a liquid level detection component for detecting the liquid level of the liquid lining structure or the fluid material in the container body;

a fluid characteristic detection component for detecting the parameters that characterize the composition, physical properties and/or chemical properties of the fluid material or the liquid lining structure in the container body.

Preferably, it further comprises a gaseous inert sealing device for providing and circulating a gaseous inert sealing medium into the container body.

To achieve above objectives, the present invention provides a cyclic inert sealing system, comprising: a liquid-sealed fluid container according to the aforementioned; and a material container, which is connected to the liquid-sealed fluid container through a material transfer control unit.

Preferably, further comprising:

a material reprocessing unit, which is operatively connected with the fluid material in the enclosed volume of the container body for realizing various reprocessing function for the fluid materials.

Preferably, the material reprocessing unit comprises at least one of the following subunits:

a material turnover subunit, which is used to realize the turnover of the fluid material in the gas and/or liquid phase;

a material purification subunit, which is used to remove impurities mixed in, dissolved or dispersed in liquid-phase fluid materials; and

a material refinement subunit, which is used to remove impurity gases mixed in, dissolved or dispersed in the gas-phase fluid materials.

To achieve above objectives, the present invention provides a QHSE storage and transportation method based on the aforementioned cyclic inert sealing system, comprising a receiving step and a feeding step:

the receiving step: input the fluid material in the material container into the enclosed volume of the container body by the material transfer control unit, so as to discharge the working fluid in the enclosed volume of the container body to the working fluid source and maintain the liquid lining structure; and/or the receiving step: output the fluid material from the enclosed volume into the material container by the material transfer control unit, the working fluid source supplementing the enclosed volume with the working fluid to maintain the liquid lining structure.

Based on the above technical solutions, the present invention uses the working fluid in the enclosed volume of the container body to form a liquid lining structure for the fluid material, so that the fluid material in the enclosed volume is isolated from the external gas phase atmosphere, which ensures the reliable storage of the fluid material. This also reduces the adverse effects of fluid materials on the external gas phase atmosphere.

### BRIEF DESCRIPTION OF THE DRAWINGS

The drawings described herein are used to provide a further understanding of the present invention and constitute a part of the present application. The schematic embodiments and the descriptions of the present invention are used to explain the present invention, and do not constitute improper limitations to the present invention.

FIG. 1 is a schematic structural view of some embodiments of a cyclic inert sealing system based on a liquid-sealed fluid container of the present invention.

FIG. 2 is a schematic structural view of some embodiments of the liquid-sealed fluid container of the present invention.

FIG. 3 is a schematic structural view of other embodiments of the liquid-sealed fluid container of the present invention.

FIG. 4 is a schematic structural view of other embodiments of the cyclic inert sealing system based on the liquid-sealed fluid container of the present invention.

FIG. 5 is a schematic structural view of still other embodiments of the cyclic inert sealing system based on the liquid-sealed fluid container of the present invention.

FIG. 6 is a schematic structural view of still other embodiments of the liquid-sealed fluid container of the present invention.

FIG. 7 is a schematic structural view of still other embodiments of the liquid-sealed fluid container of the present invention.

FIG. 8 is a schematic structural view of still other embodiments of the cyclic inert sealing system based on the liquid-sealed fluid container of the present invention.

### DETAILED DESCRIPTION OF THE PREFERRED EMBODIMENTS

Further description of the present invention will be illustrated in detail combining with the accompany drawings and the preferred embodiments.

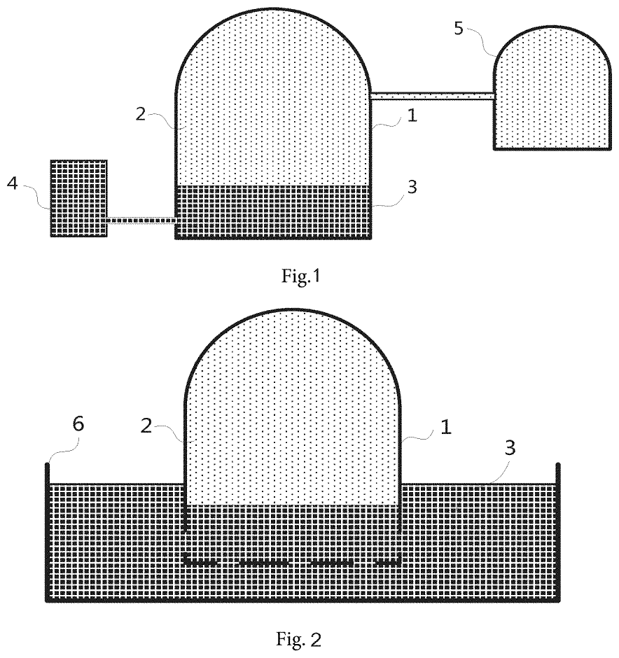

As shown in FIG. 1, it is a schematic structural view of some embodiments of a cyclic inert sealing system based on a liquid-sealed fluid container of the present invention. Referring to FIG. 1, the cyclic inert sealing system includes a liquid-sealed fluid container and a material container 5. In FIG. 1, the liquid-sealed fluid container includes: a container body 1, a working fluid 3, and a material transfer control unit. The container body 1 is provided with an enclosed volume for containing fluid materials 2. The material transfer control unit can be connected to the fluid material 2 in the enclosed volume in order to realize the input and output control of the fluid material 2 in the enclosed volume of the material container 5 in an automatic, manual and/or linkage manner. The material transfer control unit may include one or more material pipelines, which are connected to the material container 5. The ports of the material pipelines in the container body is preferably provided on the upper side wall or top of the container body, or pass through the container body from outside and are suspended below the top of the container body.

In some embodiments, according to the material flow direction, the material pipelines may include an incoming material pipeline and an outgoing material pipeline. Both the external ports of the incoming material pipeline and the outgoing material pipeline can be equipped with quick connection devices. In the incoming material pipeline, an incoming material transfer control valve group can be provided to control the flow of the fluid material from the external material container 5 to the container body 1 of the liquid-sealed fluid container. In the outgoing material pipeline, an outgoing material transfer control valve group can be provided to control the flow of fluid materials from the container body 1 to the material container 5. In order to accelerate the conveying speed of the fluid material between the material container 5 and the container body 1, the material transfer control unit may further comprise a complete set of fluid power equipment arranged in the material pipeline. According to actual needs, the complete fluid power equipment can be arranged in the incoming material pipeline and/or the outgoing material pipeline.

The working fluid 3 can be filled in the enclosed volume by purging oxygen, and is in liquid phase communicated with the working fluid source outside the container body 1. The working fluid 3 can form a liquid lining structure for the fluid material 2 in the enclosed volume, so that the fluid material 2 in the enclosed volume is isolated from the external gaseous atmosphere of the container body 1.

In some embodiments, the external gaseous atmosphere of the container body 1 may be air or other gas that is desired to be isolated from the fluid material. In some embodiments, when selecting the working fluid, the properties of the fluid material in the enclosed volume need to be considered. In order to enable the working fluid 3 to be stratified with the fluid material 2 in the enclosed volume and form a liquid lining structure of the fluid material 2, the working fluid 3 and the fluid material 2 in the enclosed volume should be incompatible or substantially incompatible, and the density of the working fluid 3 is greater than the density of the fluid material 2 in the enclosed volume. In some specific examples, according to the nature of the fluid material 2, the working fluid 3 can be selected as one or more mixed liquids among fresh water, sea water and anti-freezing solution. In addition, in order to make the density of the working fluid 3 greater than the density of the fluid material 2 in the enclosed volume, a density-increasing substance can also be added to the working fluid 3, such as adding soluble salts.

In order to avoid pollution to the external gaseous atmosphere, it is not only necessary that the working fluid can form an effective liquid lining structure to prevent the fluid material 2 from polluting the external gaseous atmosphere of the container body, but also the working fluid 3 is also preferably selected from above-mentioned liquids that will not pollute the external gaseous atmosphere.

In this embodiment, the fluid material 2 may include a single-phase fluid material or a mixture of multiple-phase fluid materials among fluid materials in a gaseous, liquid, dissolved, emulsified, and dispersed state, for example, fluid material 2 may be gasoline, diesel, crude oil, fluidized combustible ice, gaseous hydrocarbon materials or liquid hydrocarbon materials, etc. The fluid material 2 may also include a fluid in the phase transition process (such as gas-liquid two-phase natural gas, etc.), or a fluid that forms an inert atmosphere for solid substances. In other embodiments, the fluid material 2 may also include fluid materials containing some pollutants that need to be separated, purified and/or refined.

For example, when a liquid-sealed fluid container is used to store lighter oil materials such as gasoline or diesel, ordinary water (i.e., fresh water) can be used to form a liquid lining structure for the oil materials. When the oil material is fed into the enclosed volume inside the container body 1 through the material transfer control unit, the oil material can discharge the corresponding volume of water in the enclosed volume to the outside, and the oil material will be stored above the liquid lining structure. Under the isolation of the liquid lining structure, the oil material input to the container body 1 can be isolated from the external gaseous atmosphere (such as the atmosphere) of the container body 1, so as to avoid volatilization of the oil material to the atmosphere and oxidation reaction, thus not only guaranteeing the quality and safety of the oil materials, but also reducing or avoiding the atmosphere pollution from the oil materials.

In addition, the shape and composition of the fluid material 2 may also change after being input into the container body 1. For example, for crude oil materials containing more moisture, after being input into the container body 1, the lighter part of the crude oil materials will float above the liquid lining structure, while the water in the crude oil materials will be combined with the liquid lining structure , which not only realizes the storage of crude oil, but also realizes the separation of moisture in the crude oil.

In some embodiments, the liquid-sealed fluid container further includes a working fluid source. The working fluid source is in liquid phase directly or valve-controlled communicated with the working fluid liquid in the enclosed volume, for providing the working fluid to the liquid lining structure or recovering the working fluid from the liquid lining structure. In other embodiments, the working fluid source may not be a part of the liquid-sealed fluid container.

Referring to FIG. 1, in some embodiments, the liquid-sealed fluid container may further include: a liquid-lined pipeline and a liquid-lined transfer control unit. The liquid-lined pipeline is connected to the container body, and the port of the liquid-lined pipeline is located on the lower side wall or bottom of the container body, or through the container body and suspended above the bottom of the container body. The liquid-lined transfer control unit is connected to the liquid-lined pipeline and the working fluid storage tank 4 as the working fluid source, in order to keep the working fluid form the liquid lining structure in the enclosed volume by means of hydrostatic and/or power driving.

The liquid-lined transfer control unit can use power driving to forcibly adjust the liquid level of the liquid lining structure, and accordingly, the liquid liner transfer control unit can include power equipment (such as a water pump, etc.) and a delivery control valve group. The output port of the power equipment can be connected to the liquid lining structure in the container body through the delivery control valve group and the liquid-lined pipeline, and the liquid level of the liquid lining structure can be forcibly lifted to make the fluid material output outward.

In some other embodiments, the liquid-lined transfer control unit may further include a circulating spray component for spraying the working fluid toward the fluid material in the container body for purifying the fluid material. Specifically, the circulating spray assembly may include a circulating pump, a spray pipe, and a shower nozzle, which are connected by valve in sequence. The input port of the circulating pump is connected with the liquid lining structure or the working fluid source, and the output port is valve-controlled connected to the shower nozzle through the spray pipe. By operating the circulating pump, the working fluid can be extracted from the liquid lining structure or the working fluid source, and the fluid material in the enclosed volume can be sprayed and purified from the top of the container body.

In some embodiments, the working fluid source can be the working fluid storage tank 4 shown in FIG. 1 and the like. Referring to FIG. 2, in some embodiments of the liquid-sealed fluid container of the present invention, the working fluid source may also be a liquid-sealed tank 6 storing the working fluid 3. The liquid-sealed tank 6 can communicate with the atmosphere. The container body 1 can be fixedly or floatingly arranged in the liquid-sealed tank 6. The liquid lining structure in the container body 1 is in liquid phase communication with the working fluid in the liquid-sealed tank 6. When the volume of the fluid material in the container body 1 changes due to receiving, feeding, or thermal expansion and contraction, the liquid lining structure can correspondingly suck or discharge the working fluid to the working fluid source based on the siphon principle, so as to achieve the liquid level adjustment relative to the fluid material.

In FIG. 2, the bottom of the container body 1 and/or the side wall close to the bottom may be provided with liquid-lined through holes. The liquid-lined through holes can make the working fluid 3 forming the liquid-lined structure in the container body 1 be liquid-phase communicated with the working fluid 3 in the liquid-sealed tank 6. In order to maintain the liquid-phase communication of the working fluid 3, the liquid-lined through holes are preferably arranged below the liquid level of the working fluid stored in the liquid-sealed tank 6.

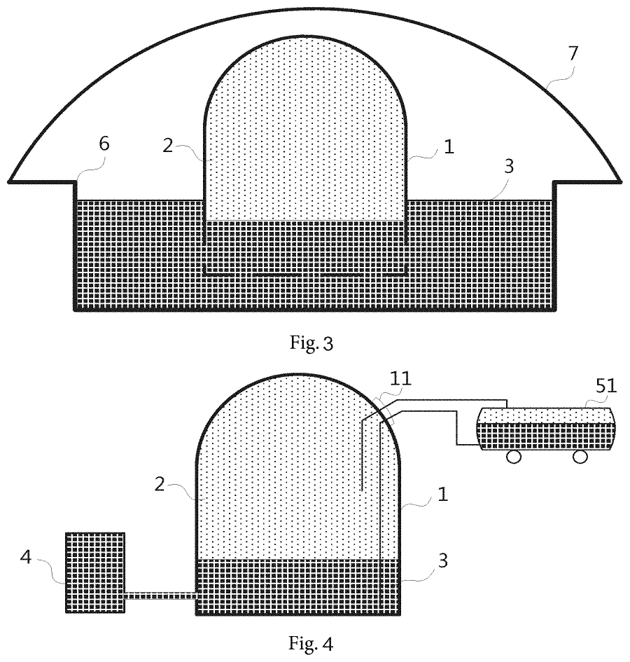

As shown in FIG. 3, it is a schematic structural view of other embodiments of the liquid-sealed fluid container of the present invention. Compared with above embodiments, the liquid-sealed fluid container further includes a construction facility 7 arranged outside the liquid-sealed tank 6. The container body 1 and the liquid-sealed tank 6 are located in an internal closed space of the construction facility 7. Correspondingly, the internal closed space forms the external gaseous atmosphere of the container body 1. According to actual needs, the internal closed space of the construction facility 7 can be in valve-controlled communication with the atmosphere or filled with protective gas, that is, a gas medium (for example, inert gas such as nitrogen) that can protect the liquid-sealed fluid container, in order to realize material safety protection or reduce working fluid pollution. Moreover, the air pressure in the closed space of the construction facility 7 can also be controlled to adjust the static pressure of the working fluid in the liquid-sealed tank 6.

Referring to FIG. 3, in some embodiments, the construction facility 7 may have a dome structure. The dome structure can be hermetically connected with the periphery or edge of the cofferdam of the liquid-sealed tank 6. In other embodiments, the dome structure can be integrally manufactured directly on the periphery or edge of the cofferdam of the liquid-sealed tank 6. Through the dome structure, the liquid level of the working fluid in the construction facility 7 can be higher than the cofferdam of the liquid-sealed tank 6. Vent pipes or vent holes can be arranged on the top of the dome structure. Pressure limiting valves can also be arranged in the vent pipes or vent holes to limit the pressure of the fluid material or the liquid lining structure in the container body.

In the cyclic inert sealing system, the container body 1 can be connected with a mobile material storage and transportation device 51 (such as a material transport vehicle) to realize the input and output of fluid materials. The material storage and transportation container 51 may also adopt a liquid lining structure of the working fluid to realize the storage and transportation of fluid materials. With reference to the embodiment of the cyclic inert sealing system shown in FIG. 4, the liquid-sealed fluid container may further include a quick-fitting plate 11 provided on the container body 1. Correspondingly, in the material transfer control unit, a first quick-fitting connection assembly is used for the input and output of the fluid material 2, one end of which is connected to the quick-fitting plate 11, and the other end is used to quickly connect to the fluid material of the material storage and transportation equipment 51 outside the container body 1. In the liquid-lined transfer control unit, a second quick-fitting assembly is used for the input and output of the working fluid 3, one end of which is connected to the quick-fitting plate 11, and the other end is used to quickly connect to the liquid lining structure formed in the material storage and transportation equipment 51.

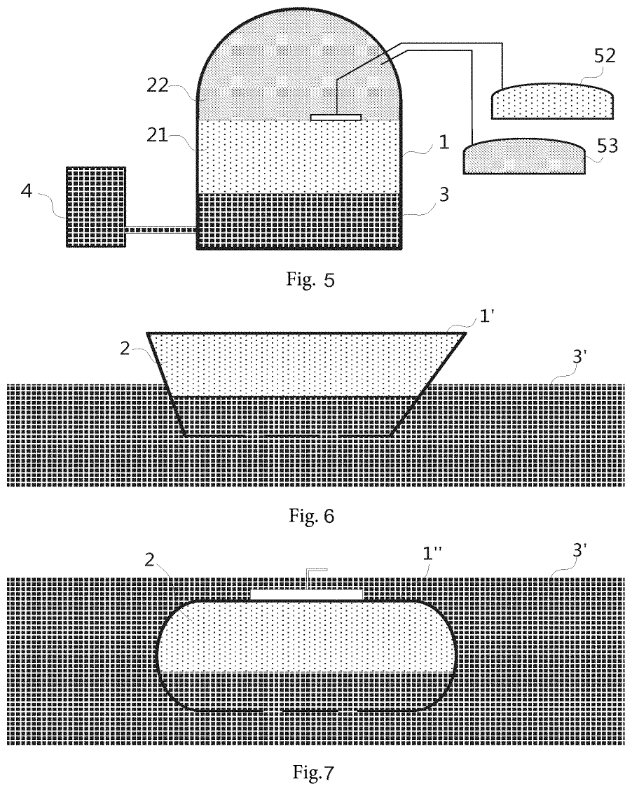

With regards to the fluid materials which are gas-liquid two-phase fluid materials (such as petroleum and natural gas extracted with petroleum, etc.), referring to the embodiment of the cyclic inert sealing system shown in FIG. 5, the material transfer control unit may include a gas-phase material transfer control subunit and a liquid-phase material transfer control subunit, which respectively realize the input and output control of the gas-phase fluid material and the liquid-phase fluid material. The gas-phase material transfer control subunit and the liquid-phase material transfer control subunit can be respectively valve-controlled connected to the gas-phase material container 53 and the liquid-phase material container 52 via pipelines. After the gas-liquid two-phase fluid material is input into the container body, it can be separated into a gas-phase fluid material 22 and a liquid-phase fluid material 21 in the container body. Through the gas-phase material transfer control subunit and the liquid-phase material transfer control subunit, the gas-phase fluid material 22 and the liquid-phase fluid material 21 can be controlled respectively to output to the gas-phase material container 53 and the liquid-phase material container 52.

In some embodiments, the gas-phase material transfer control subunit may include a gas-phase pipeline, a gas-phase fluid compressor, and a control valve. The connection between the gas phase space of the container body and the gas-phase material container 53 can be realized through the gas-phase pipeline, and the controllable output of the gas-phase fluid material 22 in the container body can be realized by controlling the gas-phase fluid compressor and the control valve.

In some embodiments, the liquid-phase material transfer control subunit may include a floating body and a liquid-phase pipeline. The density of the floating body is lower than that of the liquid-phase fluid material 21, so it floats on the liquid surface of the liquid-phase fluid material 21, and can rise and fall as the liquid surface of the liquid-phase fluid material 21 rises and falls. The floating body is provided with a connecting pipe communicating with the liquid-phase fluid material 21 and the liquid-phase pipeline. The connecting pipe can be arranged under the floating body and submerged in the liquid-phase fluid material 21. The connecting pipe can be a flexible pipe, a bendable pipe or a rigid pipe with movable joints. The liquid phase space of the container body and the liquid phase material container 52 can be connected through the liquid-phase pipeline and the connecting pipe, so as to realize the output of the liquid-phase fluid material 21 in the container body in an automatic, self-floating and/or linkage mode .

Referring to FIGS. 1 to 5, in other embodiments, a safety valve tube can be provided on the top of the container body. The safety valve tube can perform multiple functions in the liquid-sealed fluid container. For example, before the liquid-sealed fluid container is put into use, the entire enclosed volume of the container body can be filled with the working fluid first, and when the working fluid is filled, the safety valve tube can be used for discharging the gas in the enclosed volume. For another example, when the liquid-sealed fluid container needs to be stopped, the working fluid can be discharged to the outside. At this time, the safety valve tube can draw in air from the outside along with the pressure change of the internal air in the enclosed volume. For another example, when a liquid-sealed fluid container is in use, overpressure may occur, which brings safety risks, and the safety valve tube can discharge the gas in the enclosed volume in time to eliminate the risk of overpressure.

As shown in FIG. 6, it is a schematic structural view of still other embodiments of the liquid-sealed fluid container of the present invention. In FIG. 6, the working fluid source is an open water area, and water in the open water area is provided as the working fluid 3′. Open water area includes natural or artificial rivers, lakes or oceans. The container body 1′ is floatingly arranged in the open water area, and the port of the liquid lining structure is kept submerged under the liquid surface of the open water area. For example, liquid-lined through holes can be provided on the bottom of the container body 1′ and/or on the side wall close to the bottom, and the liquid-lined through holes are located below the water surface of the open water area. In order to facilitate the container body 1′ moving in the open water area, it is preferable to design the structure and shape of the container body 1′ for seaworthiness, so that it can be used as a surface towable vehicle for fluid materials. In other embodiments, existing ships can also be modified to form the liquid-sealed fluid container shown in FIG. 6.

As shown in FIG. 7, it is a schematic structural view of still other embodiments of the liquid-sealed fluid container of the present invention. Compared with the embodiment in FIG. 6, the structure and shape of the container body 1″ in this embodiment can adopt a submarine design, that is, the volume of the container body 1″ is below the liquid surface of the open water area. It can be used as an underwater towable vehicle for fluid materials to realize the transportation of fluid materials. In other embodiments, the existing submarine vehicles can also be modified to form the liquid-sealed fluid container shown in FIG. 7.

For the embodiments of the liquid-sealed fluid containers shown in FIGS. 6 and 7, they may further include a buoyancy control unit for controlling the sinking and floating of the container body in the open water. In some embodiments, the buoyancy control unit includes at least a working gas source component and a gas source transfer and control component. The working gas source component includes at least one working gas source pressure vessel and a working gas compressor, and the gas source transfer and control component may include an inflation valve tube and an exhaust valve tube.

The working gas source pressure vessel is arranged outside and/or inside the container body, and the working gas compressor is arranged outside the container body. The working gas source pressure vessel is valve-controlled communicated with the container body through the inflation valve tube, in order to fill the working gas into the container body to discharge part of the working fluid of the liquid lining structure, thereby increasing the buoyancy of the container body. The container body is also valve-controlled communicated with the exhaust valve pipe for discharging the working gas outward, so as to increase the amount of working fluid of the liquid lining structure, thereby reducing the buoyancy of the container body.

In addition, in other embodiments, the working fluid source may also be an underground water source, and water from the underground water source is provided as the working fluid. The container body is wholly or partly fixed or floatingly arranged below the water level of the underground water source. For example, in the artificially excavated geological structure for mining fluid mineral deposits, the geological structure is used as the container body to realize the storage of fluid minerals. In addition, according to needs, a spare working fluid storage tank can be connected to the liquid lining structure in the container body.

In the foregoing embodiments, the liquid-sealed fluid container may adopt a fixed structure or a movable structure. For the movable structure, the container body can be made movable, or utilizing transportation vehicles, such as train carriages, truck chassis, or ships, to carry and transport the container body.

In addition, for liquid-sealed fluid containers, the number of container bodies may be one or at least two. When the number of container bodies is at least two, the at least two container bodies can be arranged in parallel, series or series-parallel. According to needs, the fluid materials of at least two container bodies can be connected in parallel, series or series-parallel, and the liquid lining structure can also be connected in parallel, series or series-parallel. In addition, the exhaust valve pipes of each container body can also be connected in parallel, series or series-parallel. The transfer control units corresponding to the working fluid and fluid materials can be provided and controlled independently or together.

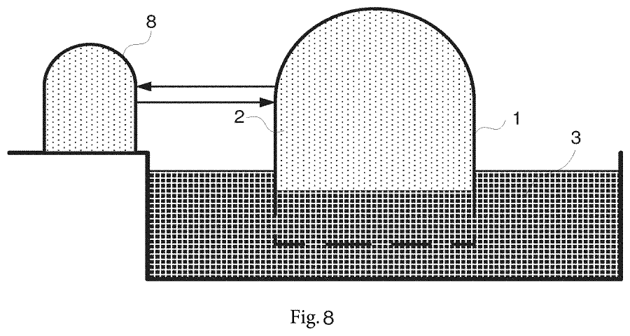

As shown in FIG. 8, it is a schematic structural view of still other embodiments of a cyclic inert sealing system based on a liquid-sealed fluid container of the present invention. Compared with the foregoing embodiments of the cyclic inert sealing system, this embodiment further includes a material reprocessing unit 8 operatively connected with the fluid material 2 in the enclosed volume of the container body 1. The material reprocessing unit 8 can realize various reprocessing function for the fluid materials 2, such as the temporary storage and turnover of the fluid materials 2, or the purification or refinement of the fluid materials 2, and so on. Correspondingly, the material reprocessing unit 8 may include one or more of a material turnover subunit, a material purification subunit, and a material refinement subunit.

The material turnover subunit can realize the turnover of the fluid material in the gas and/or liquid phase. For example, for gas-phase fluid materials, the material turnover subunit may include a pressure vessel, a pressurizing device, a check valve pipe, a pressure reducing device, etc. The pressurizing device can pressurize the gas-phase fluid material from the container body and fill into the pressure vessel through the check valve pipe. The pressure vessel can also fill the gas-phase fluid material with higher pressure back into the container body through the fluid pressure reducing device. For another example, for liquid-phase fluid materials, the material turnover unit may include a turnover container, a liquid-phase fluid pump, and a check valve pipe, etc. The liquid-phase fluid pump can pump the liquid-phase fluid material from the container body into the turnover container through the check valve tube. The liquid-phase fluid material in the turnover container can be returned to the container body through the pipeline.

The material purification subunit can be used to remove impurities (such as mechanical impurities or chemical impurities) mixed in, dissolved or dispersed in the liquid-phase fluid material, and the material refinement subunit can also remove the working fluid in the liquid-phase fluid material, so as to obtain a purer liquid-phase fluid material. The material refinement subunit can be used to remove impurity gases mixed in, dissolved or dispersed in the gas-phase fluid material to obtain a purer gas-phase fluid material.

In each of the above-mentioned embodiments of the liquid-sealed fluid container, it may further include a liquid level detection component, which can be arranged on the container body in a built-in or external manner and used to detect the liquid level of the liquid lining structure or the fluid material in the container body, in order to obtain parameters such as the volume of the liquid lining structure or the fluid material. For example, the built-in liquid level detection device may include a liquid pressure sensor, and the sensing element of the liquid pressure sensor may be arranged within the container body for detecting the layer height between the liquid lining structure and the fluid material. The external liquid level detection component may include a thermal imager and a thermal volume scale, wherein the thermal volume scale is provided on the outer surface of the container body. The measurement personnel can read the thermal volume scale through the thermal imager to obtain the volume data of the fluid material or the liquid lining structure. In addition, the thermal imager may further include a data push module to push the volume data of the fluid material or the liquid liner structure to the monitoring platform or terminals in manual, automatic and/or linkage modes.

In addition, a fluid characteristic detection component (such as a fluid characteristic sensor, etc.) can be arranged inside the container body to detect parameters characterizing the composition, physical properties and/or chemical properties of the fluid material or the liquid lining structure in the container body.

In the above embodiments, the material and structure of the container body can be manufactured according to the nature or state of the fluid material and the working fluid, and the components used in the liquid-lined transfer control unit and the material transfer control unit can also be selected according to the nature or state of the fluid material and the working fluid.

For the cyclic inert sealing system, a gaseous inert sealing device can also be added to provide and circulate a gaseous inert sealing medium, such as nitrogen or rare gas, into the container body. This gaseous inert sealing medium are not only difficult to react with fluid materials, but can also prevent fluid materials from reaching the combustion or explosion conditions as much as possible, thereby ensuring the safety of fluid materials storage.

Based on the foregoing various cyclic inert sealing systems, the present invention also proposes a corresponding QHSE storage and transportation method, including a receiving step and a feeding step, wherein:

the receiving step including: open the material transfer control unit, input the fluid material in the material container into the enclosed volume of the container body through the material pipeline, and discharge part of the working fluid that forms the liquid lining structure in the enclosed volume to the outside until completing the input of said fluid material, close the material transfer control unit;

the feeding step including: turn on the material transfer control unit, output the fluid material from the enclosed volume into the material container through the material pipeline, and receive the working fluid from the working fluid source until completing the output of said fluid material, close the material transfer control unit.

Finally, it should be noted that the foregoing embodiments are merely intended to describe the technical solutions of the present invention, rather than forming any kind of limitation. Although the present invention is described in detail with reference to the preferred embodiments, persons skilled in the art should understand that the embodiments of the present invention may still be modified or equivalently substituted for part of the technical features without departing from the spirit of the present invention, which should be covered by the technical solutions of the present invention as well.

1. A liquid-sealed fluid container, characterized that it comprises: a container body with an enclosed volume inside for containing fluid material; a working fluid, which is filled in the enclosed volume by purging oxygen and is in liquid phase communicated with the working fluid source outside the container body, in order to form a liquid lining structure for the fluid material in the enclosed volume, so that the fluid material in the enclosed volume is isolated from the external gaseous atmosphere of the container body; and a material transfer control unit, which is connected to the fluid material in the enclosed volume for realizing the input and output control of the fluid material in the enclosed volume; wherein the working fluid is incompatible or substantially incompatible with the fluid material in the enclosed volume, and the density of the working fluid is greater than that of the fluid material in the enclosed volume.

2. The liquid-sealed fluid container according to claim 1, wherein further comprising:
a liquid-lined pipeline connected to the container body, and the port of the liquid-lined pipeline is located on the lower side or bottom of the container body, or through the container body and suspended above the bottom of the container body; a liquid-lined transfer control unit, connected to the liquid-lined pipeline and the working fluid source, in order to keep the working fluid form the liquid lining structure in the enclosed volume by means of hydrostatic and/or power driving.

3. The liquid-sealed fluid container according to claim 2, wherein the liquid-lined transfer control unit comprises a circulating spray component, which is used to spray the working fluid toward the fluid material in the container body for purifying the fluid material.

4. The liquid-sealed fluid container according to claim 1, wherein further comprising a working fluid source, which is in liquid phase directly or valve-controlled communicated with the working fluid liquid in the enclosed volume, for providing the working fluid to the liquid lining structure or recovering the working fluid from the liquid lining structure.

5. The liquid-sealed fluid container according to claim 1, wherein the working fluid source is a liquid-sealed tank storing the working fluid, and the container body is fixedly or floatingly arranged in the liquid-sealed tank.

6. The liquid-sealed fluid container according to claim 5, wherein liquid-lined through holes are provided on the bottom of the container body and/or on the side wall close to the bottom, and the liquid-lined through holes are located below the liquid level of the working fluid stored in the liquid-sealed tank.

7. The liquid-sealed fluid container according to claim 5, wherein further comprising a construction facility arranged outside the liquid-sealed tank, and the container body and the liquid-sealed tank are located in an internal closed space of the construction facility.

8. The liquid-sealed fluid container according to claim 7, wherein the construction facility has a dome structure, and the dome structure is hermetically connected with the periphery or edge of the cofferdam of the liquid-sealed tank or manufactured integrally.

9. The liquid-sealed fluid container according to claim 5, wherein the liquid-sealed tank is in communication with the atmosphere.

10. The liquid-sealed fluid container according to claim 7, wherein the internal closed space is in valve-controlled communication with the atmosphere or is filled with a protective gas.

11. The liquid-sealed fluid container according to claim 2, wherein further comprising a quick-fitting plate arranged on the container body; the material transfer control unit includes a first quick-fitting connection assembly, one end of which is connected to the quick-fitting plate and the other end is used to quickly connect to the fluid material of the material storage and transportation equipment outside the container body; the liquid-lined transfer control unit includes a second quick-fitting connection assembly, one end of which is connected to the quick-fitting plate and the other end is used to quickly connect to the liquid lining structure formed in the material storage and transportation equipment.

12. The liquid-sealed fluid container according to claim 1, wherein the fluid material is a gas-liquid two-phase fluid material, and the material transfer control unit includes a gas-phase material transfer control subunit and a liquid-phase material transfer control subunit, the gas-phase material transfer control subunit is used to realize the output control of the gas-phase fluid material in the enclosed volume, and the liquid-phase material transfer control subunit is used to realize the output control of the liquid-phase fluid material in the enclosed volume.

13. The liquid-sealed fluid container according to claim 12, wherein the liquid-phase material transfer control subunit comprises a floating body and a liquid-phase pipeline, and the density of the floating body is lower than the density of the liquid-phase fluid material, and a connecting pipe is provided on the floating body to communicate with the liquid-phase fluid material and the liquid-phase pipeline.

14. The liquid-sealed fluid container according to claim 1, wherein the container body further comprises a safety valve tube connected to the top of the container body for realizing air drawing, gas discharging and overpressure protection of the entire closed volume.

15. The liquid-sealed fluid container according to claim 1, wherein the working fluid source is an open water area, and the water of the open water area is provided as the working fluid, and the container body is floatingly arranged in the open water area.

16. The liquid-sealed fluid container according to claim 15, wherein the structure and shape of the container body are designed for seaworthiness.

17. The liquid-sealed fluid container according to claim 15, wherein the structure and shape of the container body are designed as for submarine.

18. The liquid-sealed fluid container according to claim 15, wherein further comprising a buoyancy control unit for controlling the sinking and floating of the container body in the open water.

19. The liquid-sealed fluid container according to claim 1, wherein the working fluid source is an underground water source, and water from the underground water source is provided as the working fluid, and the container body is wholly or partly fixed or floatingly arranged below the water level of the underground water source.

20. The liquid-sealed fluid container according to claim 1, wherein further comprising a transport vehicle for carrying and transporting the container body.

21. The liquid-sealed fluid container according to claim 1, wherein the material transfer control unit further comprises one or more material pipelines, and the ports of the material pipelines are provided on the upper side wall or top of the container body, or through the container body and suspending below the top of the container body.

22. The liquid-sealed fluid container according to claim 1, wherein the number of the container body is at least two, and the at least two container bodies are arranged in parallel, series or series-parallel.

23. The liquid-sealed fluid container according to claim 1, wherein further comprising at least one of the following components: a liquid level detection component for detecting the liquid level of the liquid lining structure or the fluid material in the container body;
a fluid characteristic detection component for detecting the parameters that characterize the composition, physical properties and/or chemical properties of the fluid material or the liquid lining structure in the container body.

24. The liquid-sealed fluid container according to claim 1, wherein further comprising a gaseous inert sealing device for providing and circulating a gaseous inert sealing medium into the container body.

25. A cyclic inert sealing system, comprising: a liquid-sealed fluid container according to claim 1; and a material container, which is connected to the liquid-sealed fluid container through a material transfer control unit.

26. The cyclic inert sealing system according to claim 25, wherein further comprising: a material reprocessing unit, which is operatively connected with the fluid material in the enclosed volume of the container body for realizing various reprocessing function for the fluid materials.

27. The cyclic inert sealing system according to claim 26, wherein the material reprocessing unit comprises at least one of the following subunits: a material turnover subunit, which is used to realize the turnover of the fluid material in the gas and/or liquid phase; a material purification subunit, which is used to remove impurities mixed in, dissolved or dispersed in liquid-phase fluid materials; and a material refinement subunit, which is used to remove impurity gases mixed in, dissolved or dispersed in the gas-phase fluid materials.

28. A QHSE storage and transportation method based on the cyclic inert sealing system according to claim 25, characterized in that it comprises a receiving step and a feeding step:
the receiving step: input the fluid material in the material container into the enclosed volume of the container body by the material transfer control unit, so as to discharge the working fluid in the enclosed volume of the container body to the working fluid source and maintain the liquid lining structure; and/or
the receiving step: output the fluid material from the enclosed volume into the material container by the material transfer control unit, the working fluid source supplementing the enclosed volume with the working fluid to maintain the liquid lining structure.
